(19) United States
(12) Patent Application Publication
(10) Pub. No.: US 2005/0140230 A1
(43) Pub. Date: Jun. 30, 2005

(54) Electric motor and vehicle powered thereby

(76) Inventors: Michael F Johnson, Fourways (ZA); Johannes F. Wessels, Inanda (ZA)

Correspondence Address: STITES & HARBISON PLLC, 1199 NORTH FAIRFAX STREET, SUITE 900, ALEXANDRIA, VA, 22314, US

(21) Appl. No.: 10/502,977

(22) PCT Filed: Jan. 29, 2003
(86) PCT No.: PCT/ZA03/00013

(30) Foreign Application Priority Data
Jan. 30, 2002 (ZA) 2002/0814
Jul. 4, 2002 (ZA) 2002/5337

(51) Int. Cl. H02K 7/20; H02K 16/02

(52) U.S. Cl. 310/112; 310/114

(57) ABSTRACT

An electric motor (10) is disclosed, the motor (10) comprising a plurality of rotors (12) and a plurality of stators (14). Each rotor (12) has a drive shaft (16) mounted in bearings (18) and a pinion gear (20) is mounted on each shaft (16). The pinion gears (20) mesh with a main gear (22) which is connected to a main drive shaft (24) mounted in bearings (26). The pinion gears (20), main gear (22) and drive shaft (24) serve to step-down the rotational speed from the shafts (16) to the main drive shaft (24).

### FIELD OF THE INVENTION

THIS INVENTION relates to electric motors and to vehicles powered by such motors.

### BACKGROUND TO THE INVENTION

The mechanical output power of any motor is given by:
P_{mech}=T.w 1
Where
P=power,
T=mechanical torque at the drive shaft, in Nm,
w=rotational speed, in radians per second, of the drive shaft.
   The electromagnetic power of a direct current (d.c.) motor, in general, takes the form
   Pₑₘ=K.D.L.I.B.w 2
   Where
K=a constant which takes winding factors etc, into account but is not a function of size for a particular motor construction.
D=outer diameter of armature.
L=active length of armature.
I=armature current.
B=magnetic flux density of field coils (or permanent magnets) in the air gap.
w=rotational speed, in radians per second, of the drive shaft.

Power losses will be ignored since this is not a detailed analysis of the motor but serves to illustrate the concept behind the invention. Then, from equations 1 and 2 we can determine the torque;
T=K.D.L.I.B 3
From equation 3 it can be seen that for a high torque motor it is necessary to increase one or more of the parameters, diameter (D), length (L), current (I), or magnetic flux density (B). Magnetic flux density B has a maximum practical limit determined by the magnetic material used and is not a function of geometry. If D or L is increased, the size of the motor increases. Further as the current I is increased the efficiency of the motor eventually drops dramatically since resistive losses are proportional to I². Hence for a particular power rating, the power density and efficiency, and therefore the size, of the motor are determined by the torque and speed requirements. If speed and torque can be selected then, from the equations, it can be seen that a high rotational speed with low torque gives a much smaller motor for the same power rating.

Normally conventional motors operate at speeds in the region of 3000 rpm. One approach to obtain a smaller, more efficient motor of the same power rating, is to design the motor to run, say, at 12000 rpm, resulting in an equivalent decrease in torque and hence in D and L. However, a higher speed does not suit most practical applications. The obvious solution to this problem is to use a gear box to reduce the speed and increase the torque of the output shaft to practical levels. Although this solution increases size and cost, there are many applications where this solution is suitable. The solution becomes limiting as power ratings go up. This is for mechanical reasons such as centrifugal forces on the rotor become excessive at the high speeds, rotor bearings come under increased strain and windage losses become unacceptable.

The present invention seeks to a provide a high power density motor which allows for increased rotor speed without restricting the choice of drive shaft speed and torque.

### BRIEF DESCRIPTION OF THE INVENTION

According to one aspect of the present invention there is provided an electric motor construction which comprises at least two rotors including rotor shafts, there being a power output shaft and step down power transmission means connecting said rotor shafts to the output shaft.

In one form the electric motor construction comprises a number of rotor/stator combinations, said rotor/stator combinations being arranged in an array about said output shaft and there being means for connecting said combinations to one another.

In another form the electric motor construction includes at least two rotors and a single stator, the stator having cylindrical cavities therein for receiving the rotors. In this form there can be a single stator having at least two rotor cavities, said stator having a central bore in which said output shaft is mounted, said rotor cavities spaced from one another around said output shaft. Preferably said stator has four rotor cavities, the rotor cavities being equally spaced apart around said output shaft.

Bearings can be provided in said bore, said power output shaft turning in said bearings.

Outer races of rotor bearings can be fast in rotation with the stator, said rotors turning in said rotor bearings.

In a preferred form said step-down power transmission means comprises a main gear carried by said output shaft and a pinion carried by each rotor, the pinions being in mesh with said gear wheel.

Said rotors can be squirrel cage rotors having bars in which current is induced when current flows in the stator windings.

Said rotors can be in the form of permanent magnets.

The electric motor construction can further include cooling channels which pass through the or each stator, and means for causing cooling air to flow through said channels.

Said means for causing cool air to flow can be impellers driven by the rotors. A specific construction includes an impeller for blowing air into a cooling channel and an air guide for directing air emerging from that channel back into a further channel.

A further impeller can be provided for drawing air out of said further channel.

According to another aspect of the present invention there is provided, in combination, a vehicle road wheel comprising a rotatable rim and a non-rotating axle, the rim rotating with respect to the axle when the wheel is revolving, and an electric motor combination as defined above, said stator being fast with said axle and said output shaft being connected to said rim so that the rim is driven by said output shaft.

According to a further aspect of the present invention there is provided in combination, a vehicle road wheel comprising a rotatable rim and a non-rotating axle, the rim rotating with respect to the axle when the wheel is revolving, and an electric motor combination in which said step-down power transmission means comprises a main gear carried by said output shaft and a pinion carried by each rotor, the pinions being in mesh with said gear wheel, said stator being fast with said axle and said main gear and power output shaft being connected to said rim.

According to a still further aspect of the present invention there is provided a vehicle road wheel comprising a non-rotatable axle, a rotatable power output shaft, said power output shaft being hollow and said axle being co-axially within the power output shaft, there being bearings between said axle and said shaft so that the power output shaft can rotate on the axle, a stator encircling said shaft, the stator having stator cavities, rotors in said cavities, each rotor being carried by a rotor shaft, bearings between said stator and said rotor shafts so that the rotors can rotate within their cavities, a pinion on each rotor shaft and a main gear co-axial with and fast in rotation with said power output shaft, said pinions meshing with said main gear.

In this form the vehicle wheel can include a wheel rim comprising a cylindrical portion onto which a tyre can be fitted and a plate through which wheel studs project, the wheel studs being carried by said power output shaft.

To provide for braking, the vehicle road wheel can include a brake shoe in a recess in the stator and hydraulic means for urging the brake shoe against a part of the motor that rotates when the motor is running.

In one form said shoe is in a recess in an end face of the stator and is moved axially of the motor to apply the brake. In another form said shoe is in the circumference of the stator and is moved radially outwardly into contact with a rotating part of the wheel to apply the brake.

### BRIEF DESCRIPTION OF THE DRAWINGS

For a better understanding of the present invention, and to show how the same may be carried into effect, reference will now be made, by way of example, to the accompanying drawings in which:—

FIGS. 1 and 2 are a schematic front elevation and a section respectively of a first embodiment of an electric motor in accordance with the present invention;

FIGS. 3 and 4 are a schematic end elevation and a schematic side elevation respectively of a rotor of the electric motor of FIGS. 1 and 2;

FIGS. 5 and 6 are schematic end and side elevations respectively of a stator of the electric motor of FIGS. 1 and 2;

FIGS. 7 and 8 are a schematic front elevation and a diagrammatic axial section respectively of a single rotor and an associated stator, illustrating an electronic commutator arrangement;

FIG. 9 is a schematic section of a single rotor and an associated stator of the electric motor of FIGS. 1 and 2, illustrating a motor cooling and bearing lubrication system;

FIGS. 10 and 11 are a schematic front elevation and a schematic axial section of a further embodiment of a motor in accordance with the present invention;

FIG. 12 is a pictorial view of a stator for receiving multiple rotors;

FIG. 13 is a pictorial view of a squirrel cage rotor;

FIGS. 14 and 15 are a diagrammatic front elevation and a diagrammatic plan view illustrating an air cooling system for an electric motor;

FIG. 16 is an axial section through an electric motor fitted to a vehicle wheel;

FIGS. 17 and 18 are schematic representations of vehicles fitted with electric motors;

FIGS. 19 and 20 are views similar to those of FIGS. 14 and 15 and illustrate a mechanical brake; and

FIGS. 21 and 22 illustrate a further mechanical brake.

### DETAILED DESCRIPTION OF THE DRAWINGS

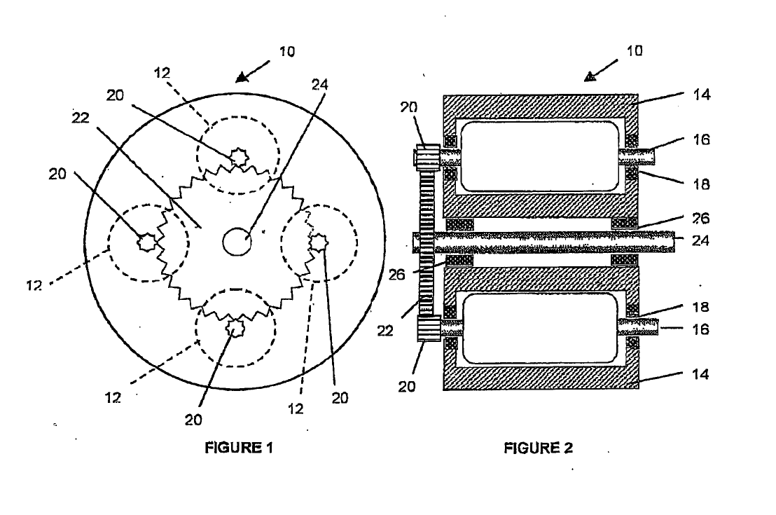

Referring firstly to FIGS. 1 and 2, an electric motor in accordance with the present invention is generally designated 10. The motor 10 comprises four rotors 12 and four stators 14. Each rotor 12 includes a drive shaft 16 mounted in bearings 18. A pinion gear 20 is mounted on each shaft 16.

The gears 20 mesh with a main gear 22 which is connected to a main drive shaft 24. The main drive shaft 24 is mounted in main shaft bearings 26. In use, all four rotors 12 are energised to drive the main gear 22 and, consequently, the main drive shaft 24.

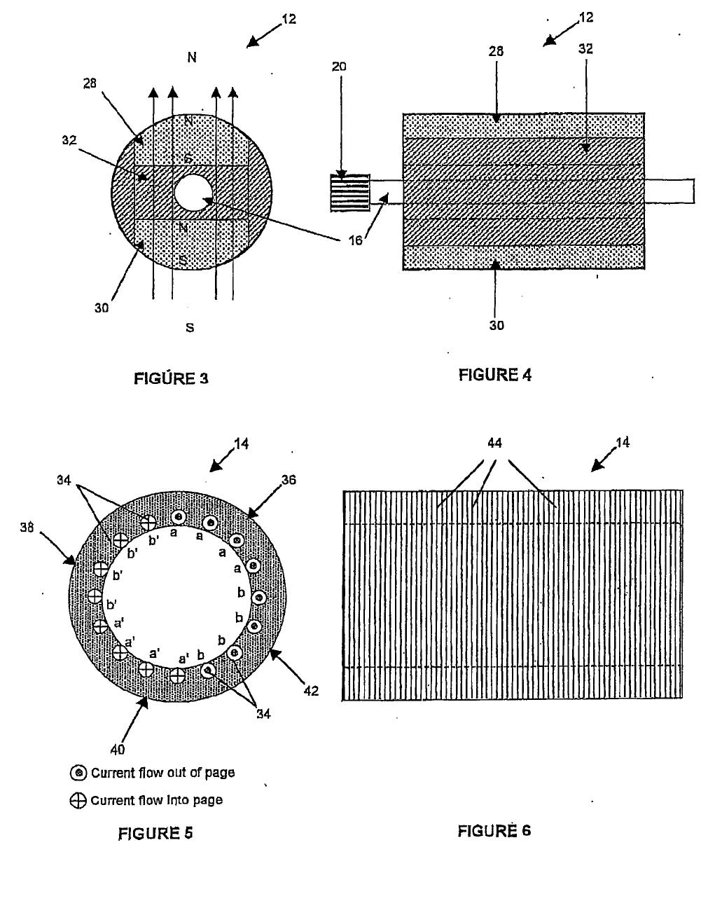

The rotor 12 includes two permanent magnets 28 and 30 (FIGS. 3 and 4) having a high magnetic flux density. The magnets 28 and 30 are mounted on opposite sides of a core portion 32. The core portion 32 is mounted on the rotor drive shaft 16. Thus, each rotor 12 only has two poles exposed on its surface, a north pole N from magnet 28 and a south pole S from magnet 30 as shown in FIGS. 3 and 4. The rotor's surfaces are smooth to reduce windage losses.

Applicants have found that whilst more than one magnetic pole pair per rotor 12 can be used this does not lead to improved performance of the motor 10. Multiple pole pairs per rotor 12 require a more complicated construction and increase the complexity of the armature windings of the stators.

The windings 34 (see FIGS. 5 and 6) are grouped into two separate phases aa′ and bb′. Windings a and a′ form a continuous coil such that the current flows in one direction through a and returns in the opposite direction through a′. Similarly, windings b and b′ form a continuous coil such that the current flows in one direction through b and returns in the opposite direction through b′. The windings 34 are therefore grouped in four quadrants 36, 28, 40 and 42 and with four windings 34 per quadrant, such that quadrants 36, 40 comprise phase aa′ and quadrants 38, 42 comprise phase bb′. The two phases aa′ and bb′ are thus positioned 90° apart from each other in mechanical angle. The phase currents when switched through aa′ and bb′, in use, are in addition switched separately at 90° apart in electrical time phase angle with respect to one another. The direction of the rotor 12 is determined by which phase is leading. The stator 14 is of laminated construction (see FIG. 6) which serves to reduce eddy current losses.

Each of the four phase windings aa′ of each of the stator 14 are connected in series and the start of the first aa′ winding and the end of the fourth aa′ winding are connected to two power terminals (not shown) for connection to a power source (not shown). Similarly, each of the four phase windings bb′ of each of the rotors 12 are connected in series and the start of the first bb′ winding and the end of the fourth bb′ winding are connected to two power terminals (not shown) for connection to a power source (not shown). Therefore, there are two terminals per phase, resulting in a total of four terminals.

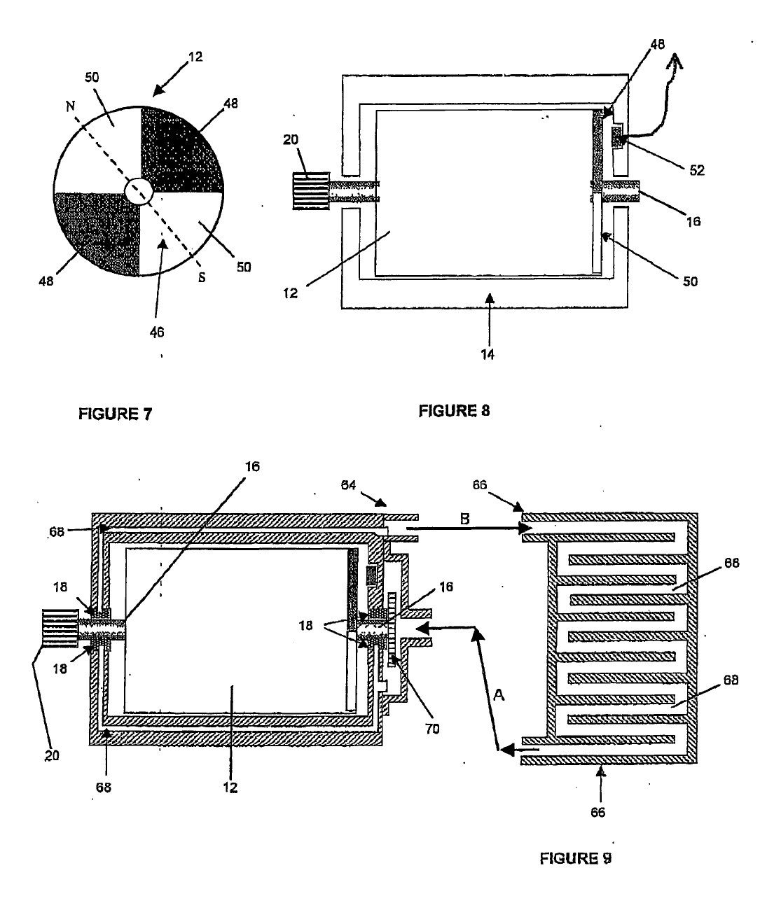

The switching of the currents through the armature windings 34 is synchronised to the rotational position of the rotors 12. In order to achieve this, one end surface 46 (see FIG. 7) of each rotor 12 is painted in two alternating, contrasting colours in four equal quadrants, preferably black 48 and white 50.

An optical sensor 52 is embedded in one of the stators 14 and faces the end surface 46 of the rotor 12 as shown in FIG. 8. The optical sensor 52 may be positioned in any one of four mechanical positions with respect to the stator windings 34 of FIG. 5:
i) between adjacent single windings a and b′;
ii) between adjacent single windings a and b;
iii) between adjacent single windings b and a′; or
iv) between adjacent single windings a′ and b′.
   In addition, the magnetic North-South axis of the rotor 12 is positioned midway in the white section 50 as indicated in FIG. 7 so that the magnets 28, 30 are located entirely within the white section 50. Alternatively, the North-South axis can be positioned perpendicular to the axis shown in FIG. 7 so that the magnets 28, 30 are located entirely within the black section 48. The optical sensor 52, together with power switching transistors (not shown), forms an electronic commutator for the electrical motor 10. Only one sensor 52 is necessary since all four rotors 12 are mechanically linked by way of the pinions 20 and the drive gear 22 and are all held in the correct position by the gear teeth.

For motors with higher power ratings, cooling system as shown in FIG. 9 may be used. The cooling system 64 comprises an air-cooled heat exchanger 66 and cooling fluid passages 68 located within the stator 14. The fluid passages 68 also lead to the rotor bearings 18. A centrifugal pump 70 is mounted on the rotor drive shaft 16. The pump 70 pumps the coolant, which is preferably oil, from the heat exchanger 66, in the direction A through the fluid passages 68 and back to the heat exchanger 66 in direction B. The coolant can thus provide lubrication for the bearings 18 as well as the cooling function as described.

Each rotor 12 of the motor 10 has its own pump 70 in this embodiment but a single pump 70 may be provided.

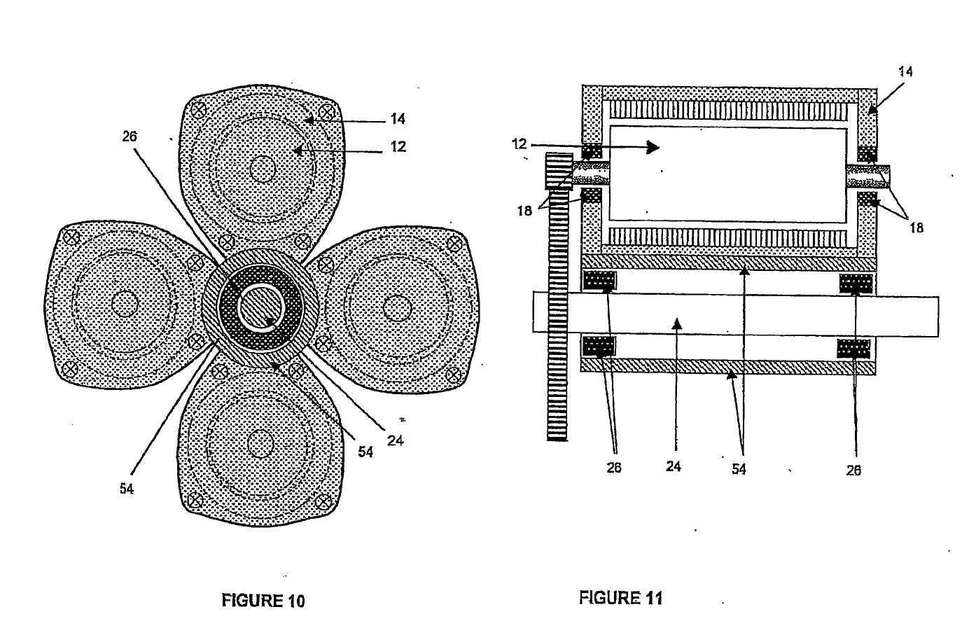

The four rotors 12 and their associated stators 14 may be constructed as four separate motors, each individually mounted about an axially extending tube 54 as shown in FIGS. 10 and 11. The tube 54 contains the main drive shaft 24 and its supporting bearings 26.

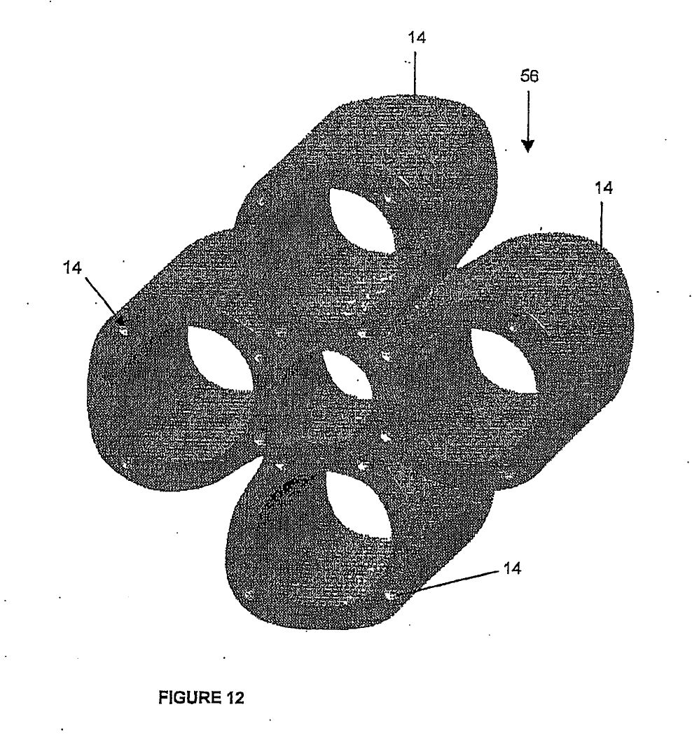

Alternatively, the four stators 14 may be constructed as one unit such as is shown at 56 in FIG. 12. Cover plates (not shown) may, in this configuration, be used as mountings for the bearings 26 of the main drive shaft 24 and the bearings 18 of the rotors 12.

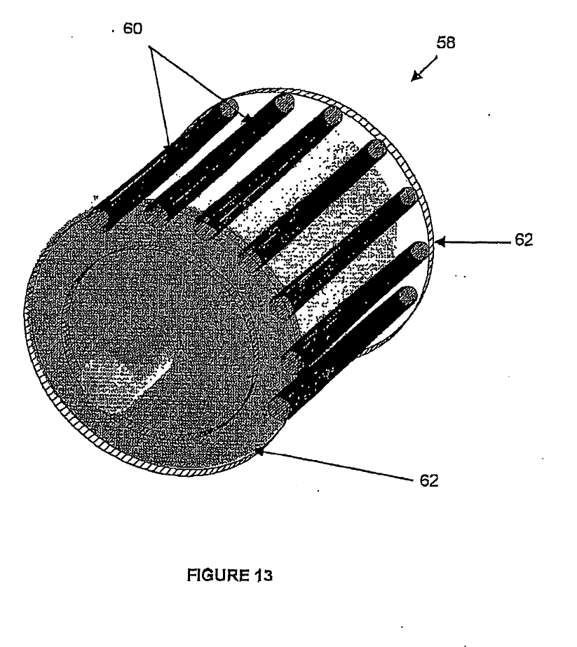

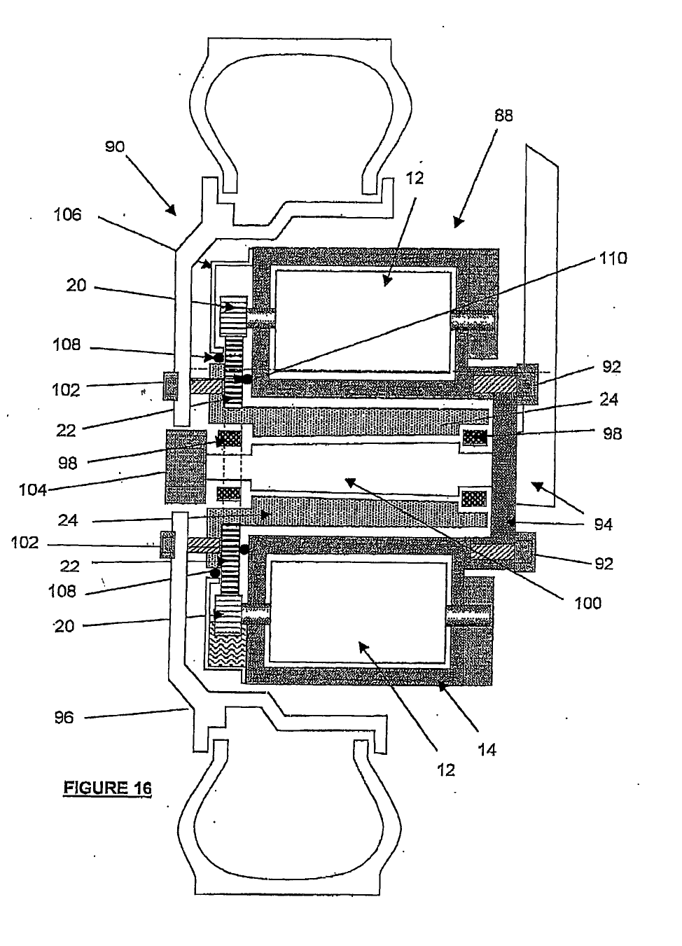

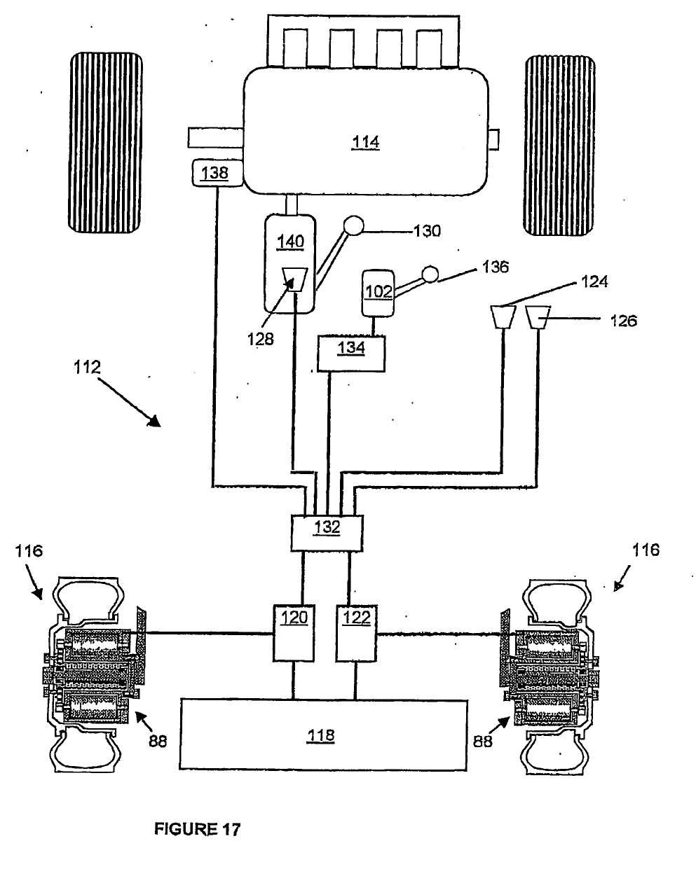

The motor disclosed in FIGS. 3 and 4 has a rotor 12 using permanent magnets 28, 30. In FIG. 13 there is disclosed a rotor 58 which comprises rotor conductor bars 60 and end conductor rings 62 forming a squirrel cage such as is used in an induction motor. Alternating current flowing in the stator windings (not shown in FIG. 13 but similar to those shown in FIG. 5) induces current in the bars 60 resulting in the production of torque which rotates the rotor 58. Four such units as shown in FIG. 13 can be used as the rotors 12 in the motor 88 shown in FIG. 16. The windings 34 are carried by the stator 14.

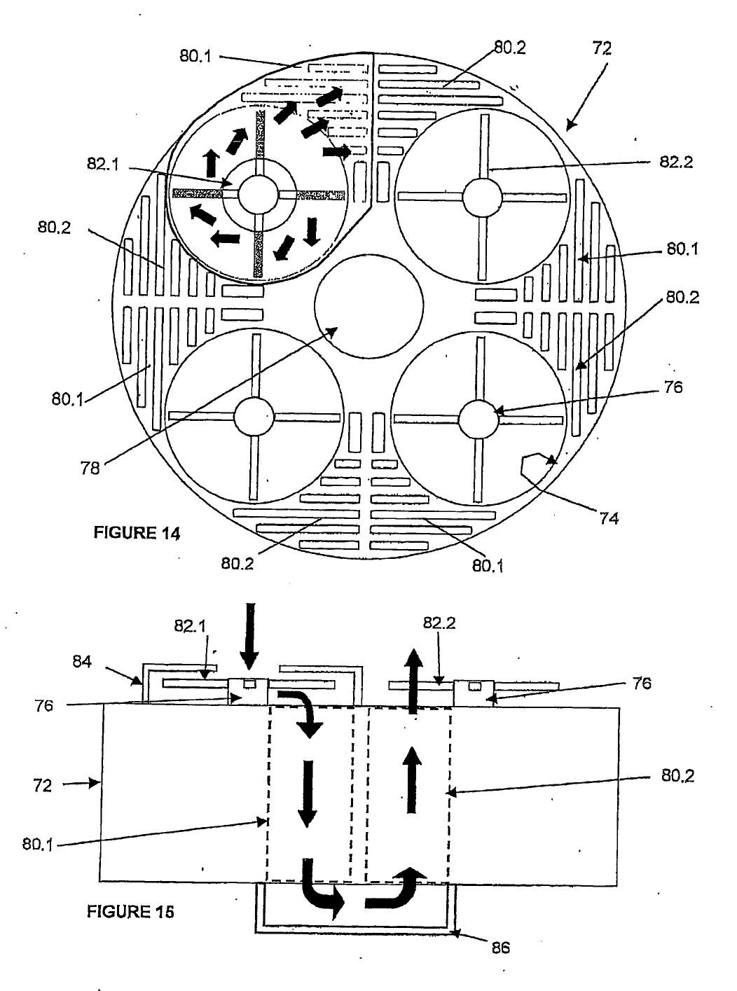

Cooling fluid or heat sink devices (not shown) may be used for cooling purposes. In FIGS. 14 and 15 a stator 72 is shown which has four cylinders 74 for receiving rotors the shafts of which are designated 76. There is a central bore 78 for a shaft (not shown) which carries the gear 22 (not shown), and a plurality of channels 80.1, 80.2.

To induce airflow through the channels 80.1, 80.2, the shafts 76 have impellers 82.1, 82.2 etc fitted to them. Air flow guides are fitted over the impellers 82.1, 82.2 etc. Only the guide 84 over the impeller 82.1 is shown. Air is drawn in by the impellers 82.1, 82.2 etc and blown into first sets of channels 80.1.

The air emerging from the sets of channels 80.1 is guided by guides 86 into second sets of channels 80.2. Airflow is shown by the arrows in FIGS. 14 and 15.

In FIG. 16 an electric motor, generally designated 88, is shown fitted to a wheel 90 by mounting bolts 92 which are screwed into the vehicle stub axle and mounting bracket assembly 94. The wheel 90 includes a wheel rim 96 which receives the motor 88. The main drive shaft 24 is hollow and turns on bearings 98 to allow the shaft 24 to rotate freely on the stub axle 100. The main gear 22 is immovably fixed to the main drive shaft 24. The wheel rim 96 is drivingly fixed to the main drive shaft 24 by way of four mounting bolts 102. The main drive shaft 24 is held in place, with the wheel bearings 98, on the vehicle stub axle 100 and mounting bracket assembly 94 by way of a single lock nut 104.

A dust cover 106 and oil seals 108, 110 protect the gear 22 and the pinion gears 20 from the ingress of dust and water. The dust cover 106 also serves as an oil reservoir to hold lubricating oil for the gear 22 and pinion gears 20.

Modification of existing conventional vehicles to incorporate the motor 88 of FIG. 16 is achieved by stripping and removing the conventional wheel hub assemblies down to the bare stub axle and mounting the motor 88, including the hollow main drive shaft 24, directly thereon.

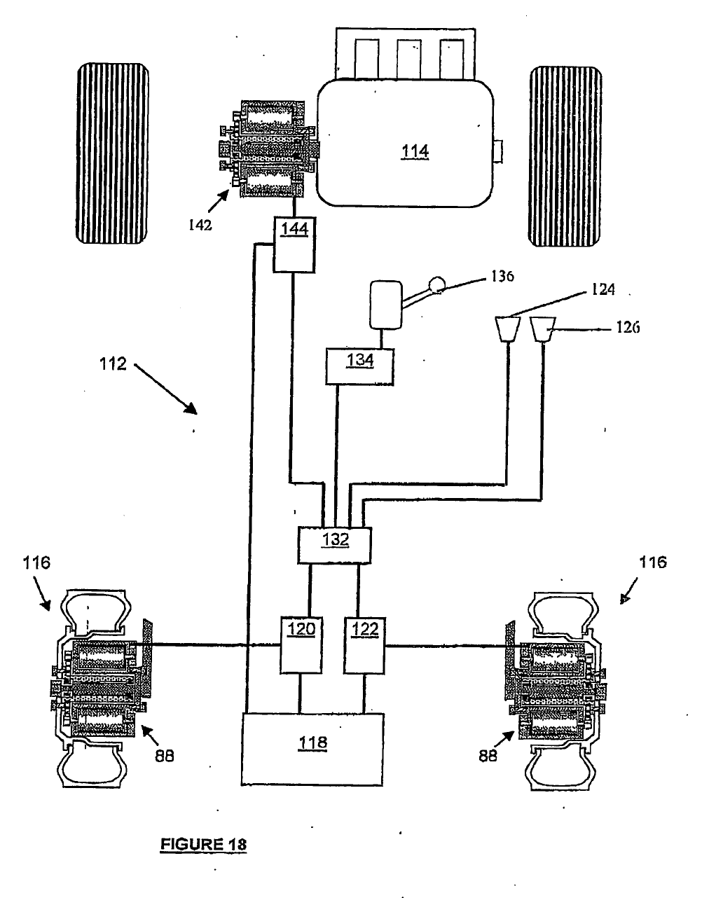

In FIG. 17 a vehicle 112 is shown schematically. The vehicle 112 includes an internal combustion engine 114. The rear wheels 116 of the vehicle 112 are fitted with electric motors 88. The motors 88 are supplied with power from a battery pack 118 via separate power supply modules 120 and 122. The power supply modules 120 and 122 control the magnitude and direction of the current. If required, the modules 120 and 122 can also change the direction of current flow between the motors 88 and the battery pack 118. Thus, the motors 88 can supply a driving force to the vehicle 112 or they can serve as generators to charge the battery pack 118. In this way, the motors 88 may also supply a regenerative braking force to the vehicle 112 while charging the battery pack 118.

Feedback transducers 124 and 126 from a brake pedal (not shown) and an accelerator pedal (not shown) respectively as well as a transducer 128 for determining the position of a gear selection lever 130 of the vehicle 112 are provided. The transducers 124, 126 and 128 are all connected to a microprocessor 132 which is used to control the operation of the modules 120 and 122.

An indicator panel 134 is provided inside the vehicle 112. A lever 136 is used to engage the motors 88 in either a forward or reverse direction. The indicator panel 134 can also include a voice command system (not shown) to allow for easier control of the system by the driver of the vehicle 112.

The microprocessor 132 also controls a starter motor 138 so as automatically to start the internal combustion engine 114 when it is necessary to switch from electric power to petrol power. A second microprocessor (not shown) may be provided to monitor the operation of the microprocessor 132. If the microprocessor 132 fails, then the second microprocessor can be used to operate the system.

A gearbox and clutch 140 is provided to connect the engine 114 to the rear wheels 116, or to the front wheels, when required.

In FIG. 18, the vehicle 112 does not have a gearbox 140 but has a generator 142 which can be of the same construction as the motors 88. The generator 142 is driven by the internal combustion engine 114 and supplies electricity directly to the motors 88. In this embodiment, the battery pack 118 is much smaller than that shown in FIG. 16 and is only required for standby power and/or surge demand purposes. A charge regulator 144, which is connected to the microprocessor 132, is provided to regulate the rate of charge of the battery pack 118. In this configuration the generator 142 drives the vehicle 112 continuously via the motors 88 and a conventional drive train for a petrol or diesel engine is not required.

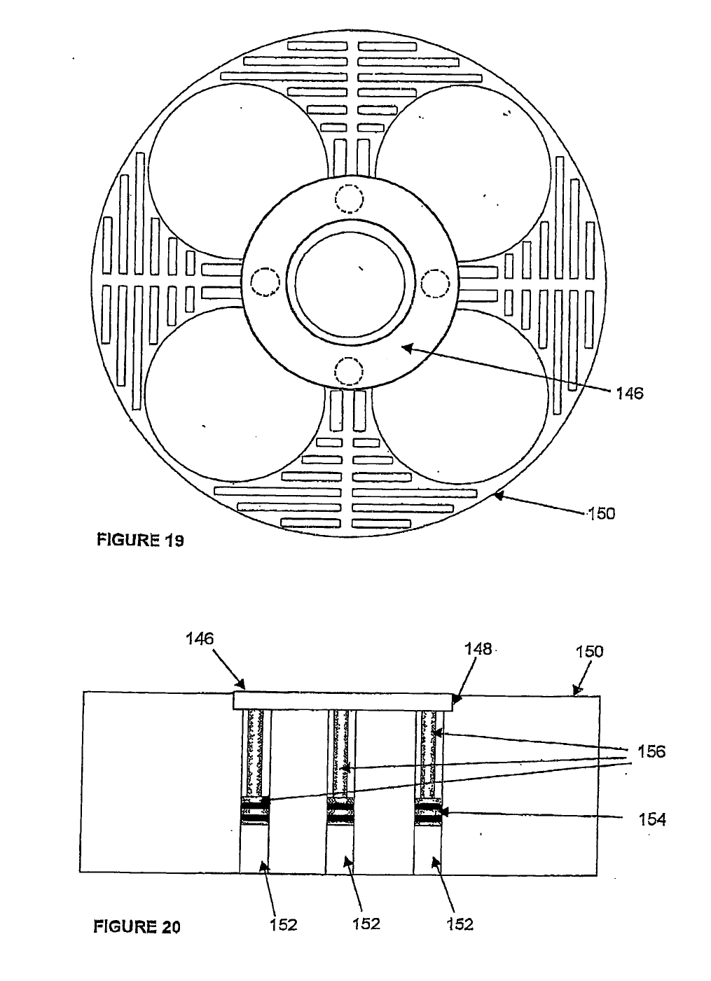

FIGS. 19 and 20 illustrate one way of incorporating a mechanical brake into an integrated wheel and motor such as is shown in the rear wheels 116 of FIG. 17. It will be understood that mechanical braking is in addition to the braking effect obtained by using the motor “in reverse” as a generator. The mechanical brake is incorporated into the motor without increasing the overall dimensions thereof.

A brake pad 146 is fitted into a recess 148 provided therefor in an end face of the stator 150. Behind the brake pad 146 there is at least one cylinder 152 (three in the illustrated embodiment) in which there are pistons 154 and piston rods 156. The rods 156 bear on the back face of the pad 146 and urge it against the gear 22. The gear 22 is not shown in FIGS. 19 and 20. The cylinders 152 are connected to an hydraulic circuit (not shown) connected to a master cylinder (not shown) operated by a brake pedal (not shown).

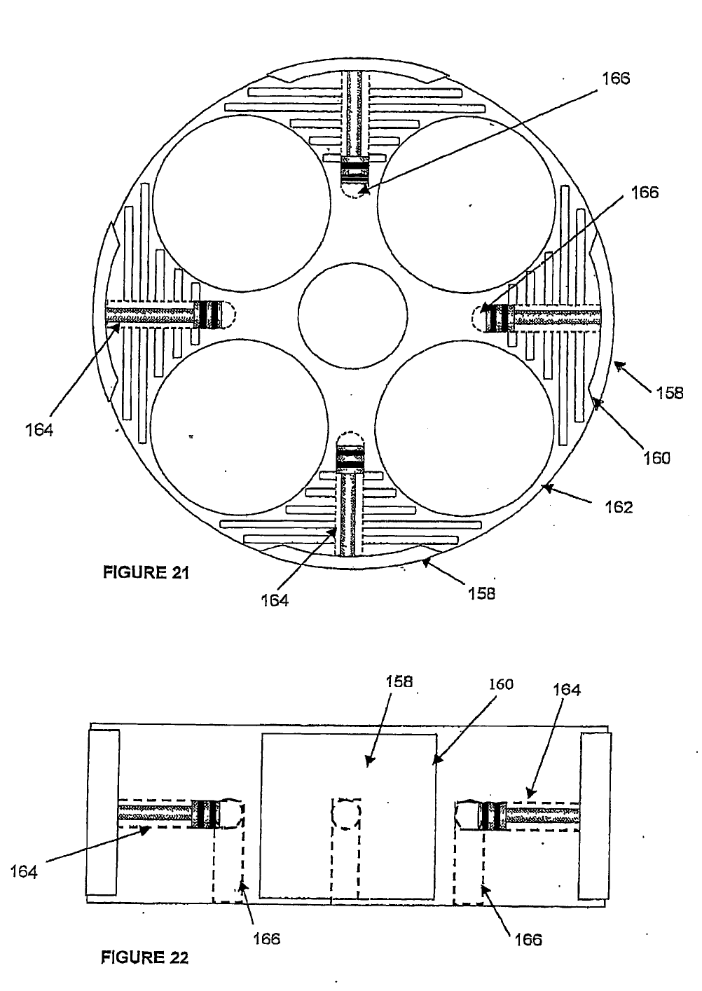

In the embodiment of FIGS. 21 and 22 brake pads 158 are mounted in recesses 160 provided therefor in the periphery of the stator 162. Cylinders 164 extend radially and, at their inner ends, join axially extending passages 166 which are connected into the hydraulic brake circuit.

1. An electric motor construction which comprises at least two rotors including rotor shafts, there being a power output shaft and step down power transmission means connecting said rotor shafts to the output shaft.

2. An electric motor construction as claimed in claim 1 and comprising a number of rotor/stator combinations, said rotor/stator combinations being arranged in an array about said output shaft and there being means for connecting said combinations to one another.

3. An electric motor construction as claimed in claim 1 and including at least two rotors and a single stator, the stator having cylindrical cavities therein for receiving the rotors.

4. An electric motor construction as claimed in claim 3, and including a single stator having at least two rotor cavities, said stator having a central bore in which said output shaft is mounted, said rotor cavities spaced from one another around said output shaft.

5-6. (canceled)

7. An electric motor construction as claimed in claim 3, wherein the stator has the outer races of rotor bearings fast therewith, said rotors turning in said rotor bearings.

8. An electric motor construction as claimed in claim 1, where said step-down power transmission comprises a main gear carried by said output shaft and a pinion carried by each rotor, the pinions being in mesh with said gear wheel.

9. An electric motor construction as claimed in claim 1 in which the rotors are squirrel cage rotors having bars in which current is induced when current flows in the stator windings.

10-13. (canceled)

14. In combination, a vehicle road wheel comprising a rotatable rim and a non-rotating axle, the rim rotating with respect to the axle when the wheel is revolving, and an electric motor construction as claimed in claim 4, said stator being fast with said axle and said output shaft being connected to said rim so that the rim is driven by said output shaft.

15. In combination, a vehicle road wheel comprising a rotatable rim and a non-rotating axle, the rim rotating with respect to the axle when the wheel is revolving, and an electric motor construction as claimed in claim 8, said stator being fast with said axle and said main gear and power output shaft being connected to said rim.

16. A vehicle road wheel comprising a non-rotatable axle, a rotatable power output shaft, said power output shaft being hollow and said axle being co-axially within the power output shaft, there being bearings between said axle and said shaft so that the power output shaft can rotate on the axle, a stator encircling said shaft, the stator having stator cavities, rotors in said cavities, each rotor being carried by a rotor shaft, bearings between said stator and said rotor shafts so that the rotors can rotate within their cavities, a pinion on each rotor shaft and a main gear c-axial with and fast in rotation with said power output shaft, said pinions meshing with said main gear.

17. A vehicle wheel as claimed in claim 16, and including a wheel rim comprising a cylindrical portion onto which a tyre can be fitted and a plate through which wheel studs project, the wheel studs being carried by said power output shaft.

18.-20. (canceled)
